(19) United States
(12) Patent Application Publication
(10) Pub. No.: US 2005/0230399 A1
(43) Pub. Date: Oct. 20, 2005

(54) Vacuum insulating double vessel and method for manufacturing the same

(75) Inventors: Takafumi Fujii, Tokyo (JP); Eiji Otsuka, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: THERMOS K.K., Nishikanbara-gun (JP)

(21) Appl. No.: 10/824,441

(22) Filed: Apr. 15, 2004

(51) Int. Cl. B01D 8/00

(52) U.S. Cl. 220/592.17

(57) ABSTRACT

The present invention provides a vacuum insulating double vessel having transparent slits and a method for manufacturing the same which can form transparent slits safely and simply without using any particular equipment and particular chemical and which can be mass-produced at a low cost. This vacuum insulating double vessel includes a vacuum insulating layer provided between an inner vessel and an outer vessel of the double vessel made of a transparent material, and metal films applied to the outer surface of the inner vessel and the inner surface of the outer vessel which face the vacuum insulating layer, and the vacuum insulating double vessel comprises strip-shaped metal film unapplied portions in a vessel height direction in the metal film applied portions, and a plurality of opening vestiges, on the outer vessel, which result from sealing a plurality of openings used for injecting and discharging chemical solutions for applying the metal films, and used as air passages.

### BACKGROUND OF THE INVENTION

1. Field of the Invention

The present invention relates to a vacuum insulating double vessel and a method for manufacturing the same, and more particularly, it relates to a vacuum insulating double vessel which is made of a transparent material and in which metal films are applied onto portions which face vacuum insulating layers of the vacuum insulating double vessel, strip-shaped metal film unapplied portions, i.e., transparent slits in a vessel height direction in which the metal films are not applied being partially formed in the metal film forming portion, as well as a method for manufacturing the vacuum insulating double vessel.

2. Description of the Related Art

In a vacuum insulating double vessel made of a transparent material, for example, a vacuum bottle made of glass, there are provided a vacuum insulating layer between an inner glass vessel and an outer glass vessel to suppress the thermal conduction, and silver plating on two glass surfaces which face the insulating layer to suppress the heat dissipation due to radiation. However, when the silver plating is applied to the whole surface of the glass, the state in the vessel, for example, an amount of the liquid could not be visually confirmed. Consequently, it has been proposed to provide transparent portions (transparent slits), to which silver plating is not applied, in portions of the glass surfaces, thereby enabling a user to visually confirm the interior of the vessel through the transparent slits.

In the event that metal films for preventing the heat radiation provided at predetermined position with transparent slits are previously applied to the portions which face an insulating layer of inner and outer vessels constituting a double vessel, or the outer surface of the inner vessel and the inner surface of the outer vessel, and thereafter the inner and outer vessels are welded to each other to form a double construction, the inner and outer vessels are exposed to a high temperature atmosphere so that the metal films tend to be oxidized to lose the performance of radiation preventing films. The radiation preventing films such as silver plating, therefore, must be provided after the double construction of the inner and outer vessels have been completed.

As a method for applying films to the outer surface of an inner vessel and the inner surface of an outer vessel after the inner and outer vessels are jointed into a double construction, it has been known that, for example, an activating liquid is applied onto the inner and outer glass surfaces which face a vacuum insulating layer, and radiation exposure is applied to portions which are not scheduled to be provided with silver plating, and thereafter a silver plating producing chemical solution is injected so that the silver plating is applied to required portions only. Moreover, a method is also known that before obtaining a double construction by welding an inner glass vessel and an outer glass vessel, masks are attached to side surfaces of the vessels and a metal is vapor-deposited thereon. Silicon dioxide is further vapor-deposited on the metal vapor-deposited surfaces, and thereafter the masks are peeled and the inner and outer glass vessels are welded to each other to obtain the double construction.

In the prior art methods, however, many process steps may be required and the respective steps may be complicated so that particular mechanical equipment and particular chemical solutions may be required and therefore reduction in manufacturing cost would also be difficult.

### SUMMARY OF THE INVENTION

It is an object of the present invention to provide a vacuum insulating double vessel having transparent slits and a method for manufacturing the same which can form transparent slits safely and simply without using any particular equipment and particular chemical and which can be mass-produced at a low cost.

A vacuum insulating double vessel of the present invention includes a vacuum insulating layer provided between an inner vessel and an outer vessel of the double vessel made of a transparent material, and metal films applied to the outer surface of the inner vessel and the inner surface of the outer vessel which face the vacuum insulating layer. The vacuum insulating double vessel comprises strip-shaped metal film unapplied portions in a vessel height direction in the metal film applied portions, and a plurality of opening vestiges, on the outer vessel, which result from sealing a plurality of openings used for injecting and discharging chemical solutions for applying the metal films, used as air passages and used for evacuating a space between the inner and outer vessels.

Furthermore, in the vacuum insulating double vessel of the present invention, the transparent material is glass, and tip tubes are used for the openings. In addition, a plurality of the openings are provided at opposite positions on the outer periphery of the bottom of the outer vessel.

A first method for manufacturing a vacuum insulating double vessel of the present invention including a vacuum insulating layer provided between an inner vessel and an outer vessel of the double vessel made of a transparent material, and metal films applied to the outer surface of the inner vessel and the inner surface of the outer vessel which face the vacuum insulating layer comprises steps of locating, at an upper position, one opening of a plurality of openings provided in the outer vessel in a condition where an axis of the double vessel before formation of the metal films is directed to a horizontal direction; injecting a chemical solution for forming metal films into the space between the inner vessel and the outer vessel while exhausting air in a space between the inner vessel and the outer vessel to apply the metal film onto the outer surface of the inner vessel and the inner surface of the outer vessel except for portions of the outer surface and the inner surface in the form of a strip in a vessel height direction; locating, at a lower position, one opening of a plurality of the openings to discharge the chemical solution; evacuating the space between the inner vessel and the outer vessel of the double vessel through the opening; and then sealing the openings to form a vacuum insulating layer between the inner vessel and the outer vessel.

A second method for manufacturing the vacuum insulating double vessel of the present invention according to the first method, wherein a width of the portions to which the metal films are not applied is regulated by adjusting a rotating angle of the double vessel after the chemical solution for forming the metal films has been injected into the space between the inner vessel and the outer vessel.

A third method for manufacturing a vacuum insulating double vessel of the present invention including a vacuum insulating layer provided between an inner vessel and an outer vessel of the double vessel made of a transparent material, and metal films applied to the outer surface of the inner vessel and the inner surface of the outer vessel which face the vacuum insulating layer comprises steps of directing, in a horizontal direction, an axis of double vessel before formation of the metal films; immersing the double vessel into a chemical solution for forming the metal films in a condition where one opening of a plurality of openings provided in the outer vessel is located at an upper position; injecting a first chemical solution for forming the metal films into a space between the inner vessel and the outer vessel through the opening, located at a lower position, of a plurality of the openings until there is reached such a state that portions of the outer surface of the inner vessel and the inner surface of the outer vessel are left in the form of a strip in a vessel height direction, while exhausting air in the space between the inner vessel and the outer vessel through the opening located at the upper position; locating, at a lower position, one opening of the plurality of openings to discharge the first chemical solution through the one opening; locating, at an upper position, one opening of the plurality of the openings provided in the outer vessel; injecting a second chemical solution for forming the metal films into the space between the inner vessel and the outer vessel while exhausting air in the space between the inner vessel and the outer vessel through the opening to apply the metal films to the outer surface of the inner vessel and the inner surface of the outer vessel, portions of the outer surface of the inner vessel and the inner surface of the outer vessel being left in the form of a strip in a vessel height direction; locating, at a lower position, one opening of the plurality of openings to discharge the second chemical solution through the opening; evacuating the space between the inner vessel and the outer vessel of the double vessel through the opening; and then sealing the openings to form a vacuum insulating layer between the inner vessel and the outer vessel.

According to the present invention, a vacuum insulating double vessel having transparent slits in a vessel height direction can be obtained safely and simply without using any particular equipment and particular chemical. Therefore, the vacuum insulating double vessel having transparent slits, for example, a vacuum bottle can be mass-produced at a low cost.

### BRIEF DESCRIPTION OF THE DRAWINGS

FIGS. 1 to 5 illustrate the first embodiment of the present invention;

FIG. 1 is a sectional front view of a double glass vessel before metal films (silver plating) are formed;

FIG. 2 is a bottom plan view of the double glass vessel shown in FIG. 1;

FIG. 3 is an explanatory view of operations for applying the silver plating to the outer surface of the inner vessel and the inner surface of the outer vessel of the double glass vessel;

FIG. 4 is an explanatory view of steps for injecting the chemical solution into the space between the inner vessel and the outer vessel of the double glass vessel;

FIG. 5 is a front view of a vacuum insulating double glass vessel which has been formed with silver plating provided with transparent slits on the outer surface of the inner vessel and the inner surface of the outer vessel of the double glass vessel, and openings have been sealed;

FIGS. 6 to 8 illustrate one example of a pot accommodating therein a vacuum insulating double glass vessel according to the present invention;

FIG. 6 is a front view of the pot;

FIG. 7 is a partly sectional front view of the pot;

FIG. 8 is a partly sectional side view of the pot;

FIGS. 9 to 15 illustrate the second embodiment of the present invention;

FIG. 9 is an explanatory view of a state viewed from the side in which a double glass vessel is immersed in a first chemical solution for forming the metal films to pour the first chemical solution for forming the metal films into the space between the inner vessel and the outer vessel;

FIG. 10 is an explanatory view of a state viewed from the side in which the first chemical solution for forming the metal films has been injected into the space between the inner vessel and the outer vessel by immersing a double glass vessel into a first chemical solution for forming the metal films;

FIG. 11 is a explanatory view of a state viewed from the above in which the first chemical solution is injected into the space until portions of the outer surface of the inner vessel and the inner surface of the outer vessel remain in the form of a strip in a vessel height direction;

FIG. 12 is an explanatory view of a state viewed from the side in which the double glass vessel is lifted from the first chemical solution for forming the metal films to discharge the first chemical solution for forming the metal films from the space between the inner vessel and the outer vessel;

FIG. 13 is an explanatory view of a state viewed from the side in which a second chemical solution for forming the metal film is being injected into the space between the inner vessel and the outer vessel of the double glass vessel;

FIG. 14 is an explanatory view of a state viewed from the side in which a predetermined amount of the second chemical solution for forming the metal film has been injected into the space between the inner vessel and the outer vessel of the double glass vessel;

FIG. 15 is a sectional view of the double glass vessel illustrating the state that the silver plating is applied to the outer surface of the inner vessel and the inner surface of the outer vessel of the double glass vessel;

FIGS. 16 to 19 illustrate the third embodiment of the present invention;

FIG. 16 is a sectional front view of a double glass vessel before the metal films (silver plating) are formed;

FIG. 17 is a bottom plan view of the double glass vessel shown in FIG. 16;

FIG. 18 is an explanatory view of the operation for applying the silver plating to the outer surface of the inner vessel and the inner surface of the outer vessel of the double glass vessel;

FIG. 19 is a front view of the vacuum insulating double glass vessel in which the silver plating with transparent slits is applied to the outer surface of the inner vessel and the inner surface of the outer vessel of the double glass vessel;

FIGS. 20 and 21 illustrate the fourth embodiment of the present invention;

FIG. 20 is an explanatory view of one example of the operation for applying the silver plating to the outer surface of the inner vessel and the inner surface of the outer vessel of the double glass vessel;

FIG. 21 is an explanatory view of the other example of the operation for applying the silver plating to the outer surface of the inner vessel and the inner surface of the outer vessel of the double glass vessel;

FIGS. 22 to 24 illustrate the fifth embodiment of the present invention;

FIG. 22 is a sectional front view of a double glass vessel;

FIG. 23 is an explanatory view of one example of the operation for applying the silver plating to the outer surface of the inner vessel and the inner surface of the outer vessel of the double glass vessel;

FIG. 24 is an explanatory view of the other example of the operation for applying the silver plating to the outer surface of the inner vessel and the inner surface of the outer vessel of the double glass vessel;

FIGS. 25 to 28 illustrate the sixth embodiment of the present invention;

FIG. 25 is a sectional front view of the double glass vessel;

FIG. 26 is an explanatory view of one example of the operation for applying the silver plating to the outer surface of the inner vessel and the inner surface of the outer vessel of the double glass vessel;

FIG. 27 is an explanatory view of the other example of the operation for applying the silver plating to the outer surface of the inner vessel and the inner surface of the outer vessel of the double glass vessel; and

FIG. 28 is an explanatory view of one example of the operation for applying the silver plating to the inner vessel of the outer surface and the inner surface of the outer vessel at the bottom of the double glass vessel.

### BEST MODE FOR CARRYING OUT THE INVENTION

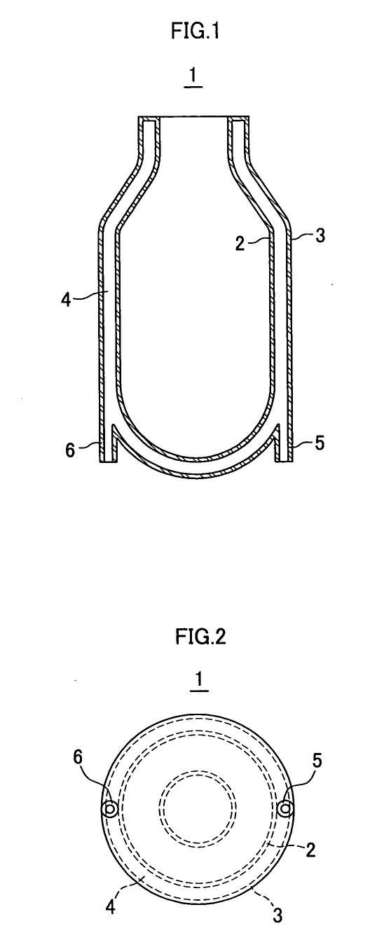

FIGS. 1 to 5 illustrate one example of the first embodiment of the present invention. As shown in FIGS. 1 and 2, a double glass vessel 1, before being formed with silver plating as a metal film, is provided with a vacuum insulating layer forming portion 4 formed between an inner vessel 2 and an outer vessel 3 being welded together at their upper opening portions. The outer vessel 3 is provided at its bottom with tip tubes 5 and 6 opening into the vacuum insulating layer forming portion 4 at two diametrically opposite positions of the bottom periphery of the outer vessel 3.

The tip tubes 5 and 6 are used as passages for injecting and discharging chemical solutions for applying metal films (silver plating) to the outer surface of the inner vessel and the inner surface of the outer vessel which face the vacuum insulating layer forming portion 4, and further passages for air, respectively.

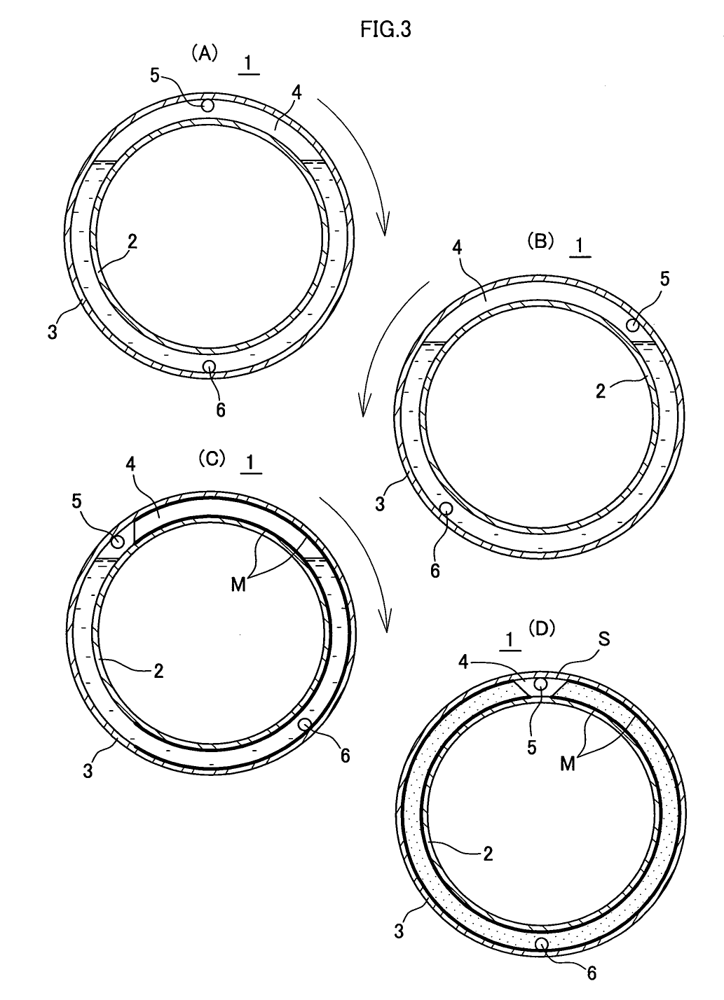

According to a procedure shown in FIG. 3 using the two tip tubes 5 and 6 as the passages for injecting and discharging the chemical solutions and the passages for air, respectively, silver plating M is applied to the outer surface of the inner vessel and the inner surface of the outer vessel of the double glass vessel 1 which face the vacuum insulating layer forming portion 4 except for portions, in the form of a strip in a vessel height direction, of the outer and inner surfaces of the inner and outer vessels to form transparent strip-shaped slits S in the height direction of the double glass vessel.

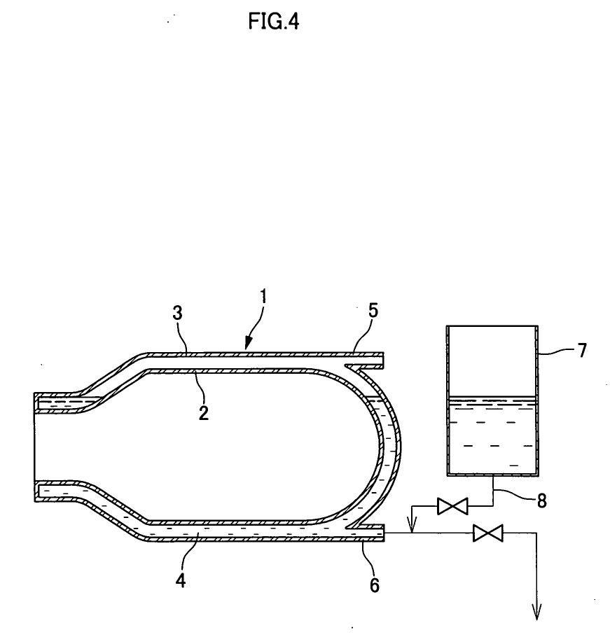

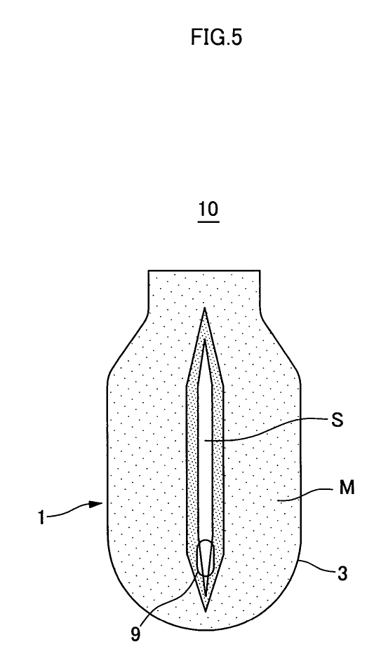

First, as shown in FIGS. 3A and 4, the double glass vessel 1 is positioned with its axis in the horizontal direction and with one tip tube 6 at the lowermost position. Under this condition, a first silver plating producing chemical solution, for example, an aqueous tin (IV) chloride solution in a chemical solution vessel 7 is injected into the vacuum insulating layer forming portion 4 through a tube 8 from the tip tube 6 located at the lower position. In this case, the air in the vacuum insulating layer forming portion 4 is exhausted from the other tip tube 5 located at an upper position so that the chemical solution can be easily injected into the vacuum insulating layer forming portion 4. The first silver plating producing chemical solution is injected into the portion 4 by a predetermined amount or until the liquid level of chemical solution comes into a predetermined position.

After the first silver plating producing chemical solution has been injected, the double glass vessel 1 is rotated about its axis through a predetermined angle, for example, 45 degrees clockwise into the condition shown in FIG. 3B. After the double glass vessel 1 in this state has been left or held as it is for a few minutes, it is rotated about its axis in the opposite direction through a predetermined angle, for example, 90 degrees counterclockwise into the condition shown in FIG. 3C. After the double glass vessel 1 in this state has been left or held as it is for a few minutes, moreover, it is rotated about its axis through 45 degrees clockwise to the initial state or the state of the tip tube 6 being at the lowermost position (FIG. 3A) to discharge the first silver plating producing chemical solution from the vacuum insulating layer forming portion 4 through the tip tube 6. The first silver plating producing chemical solution can also be readily discharged because the air flows into the vacuum insulating layer forming portion 4 through the other tip tube 5 located at the upper position.

Thereafter, under this condition of the double glass vessel 1 (the state shown in FIG. 3A), a second silver plating producing chemical solution, for example, a silver mirror reaction chemical solution, such as an aqueous silver nitrate solution is injected from the tip tube 6 into the vacuum insulating layer forming portion 4. The second silver plating producing chemical solution is also injected into the portion 4 by a predetermined amount or until the liquid level of the chemical solution comes into a predetermined position. In the same manner as in the case of the first silver plating producing chemical solution, the double glass vessel 1 is then rotated about its axis through 45 degrees clockwise into the condition shown in FIG. 3B and it is left in this state for a few minutes and again rotated through 90 degrees counterclockwise into the state shown in FIG. 3C, under the condition of which the double glass vessel 1 is left in this state for a few minutes. Then, the double glass vessel 1 is rotated through 45 degrees clockwise into the condition shown in FIG. 3A to discharge the second silver plating producing chemical solution from the vacuum insulating layer forming portion 4 through the tip tube 6. Thereafter, cleaning and drying operations are carried out.

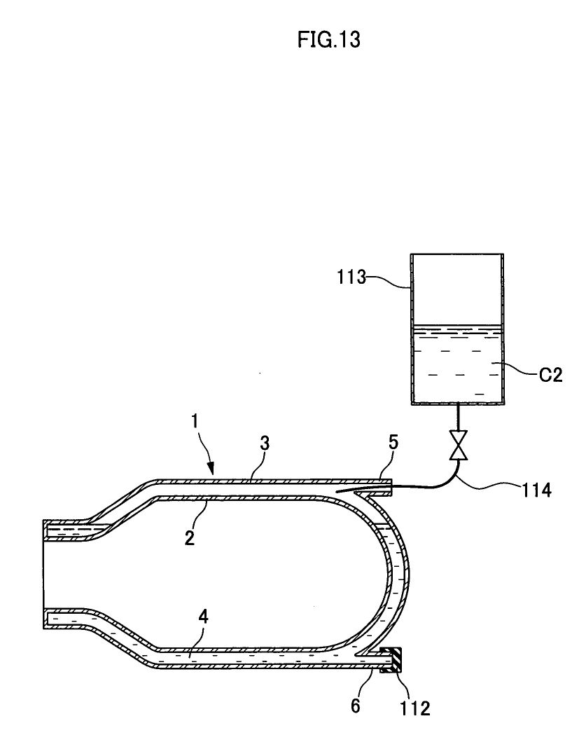

As described above, the respective operations are carried out in a manner of injecting the first silver plating producing chemical solution and the second silver plating producing chemical solution into the vacuum insulating layer forming portion 4, rotating the double glass vessel through the predetermined angles and then discharging the chemical solutions, with the result that the silver plating M is applied to the portions, to be provided with the metal films, of the outer surface of the inner vessel and the inner surface of the outer vessel which have contacted the respective silver plating producing chemical solutions, while the transparent slits S in the direction of the vessel height are formed leaving the strip-shaped metal film unapplied portions which have not contacted the respective silver plating producing chemical solutions. Moreover, the silver plating producing chemical solutions may be injected by any method. For example, the method shown in FIG. 13 described later may be performed.

After the silver plating process, the vacuum insulating layer forming portion 4 is evacuated using the tip tube to form a vacuum insulating layer between the inner and outer vessels 2 and 3. After the evacuation, the tip tubes 5 and 6 are sealed. In this manner, as shown in FIG. 5, a vacuum insulating double glass vessel 10 is formed which has transparent slits S composed of strip-shaped metal film unapplied portions in the direction of the vessel height in the metal film applied portions of the silver plating M, and has at the bottom of the outer vessel 3 a plurality of opening vestiges 9 formed by sealing the openings of the tip tubes 5 and 6. In sealing the tip tubes 5 and 6, after one of the tip tubes has been sealed, the evacuation may be effected through the other tip tube which may then be sealed.

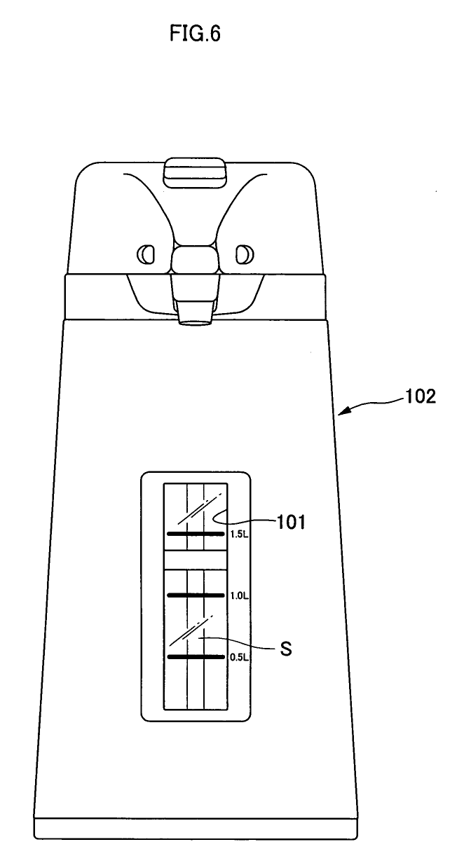

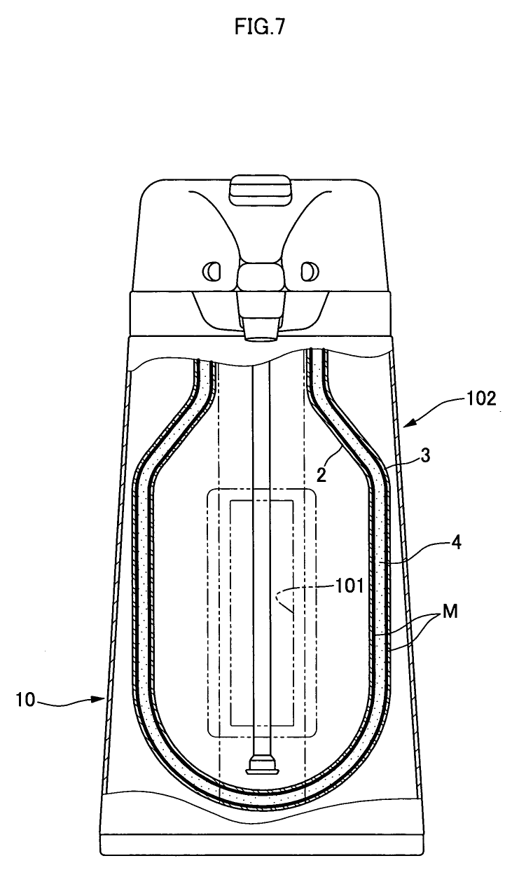

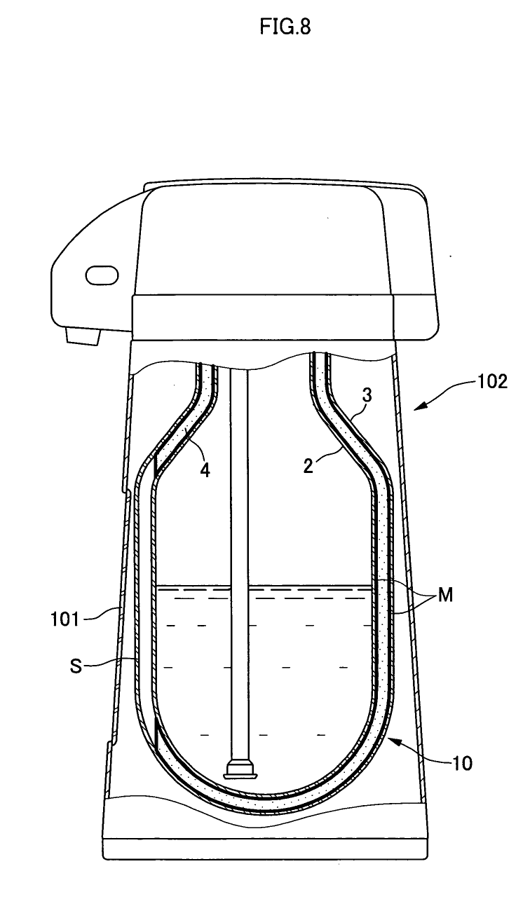

FIGS. 6 to 8 illustrate one example of a pot having a vacuum insulating double glass vessel according to the present invention accommodated therein. When the vacuum insulating double glass vessel 10 formed as described above is used as a vacuum bottle, the vacuum insulating double glass vessel 10 is inserted into a vacuum bottle housing 102 having a transparent window 101 in its front surface so that the glass vessel 10 is fixed to the housing 102 with the transparent slits S immediately inside the transparent window 101 of the housing 102. This makes it possible to ascertain the amount of the hot water inside the bottle through the transparent window 101 and the transparent slits S.

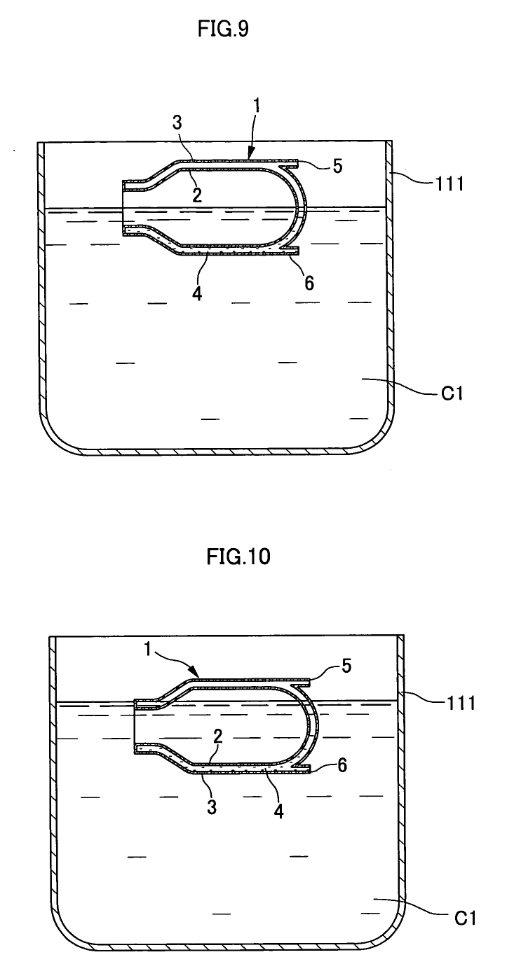

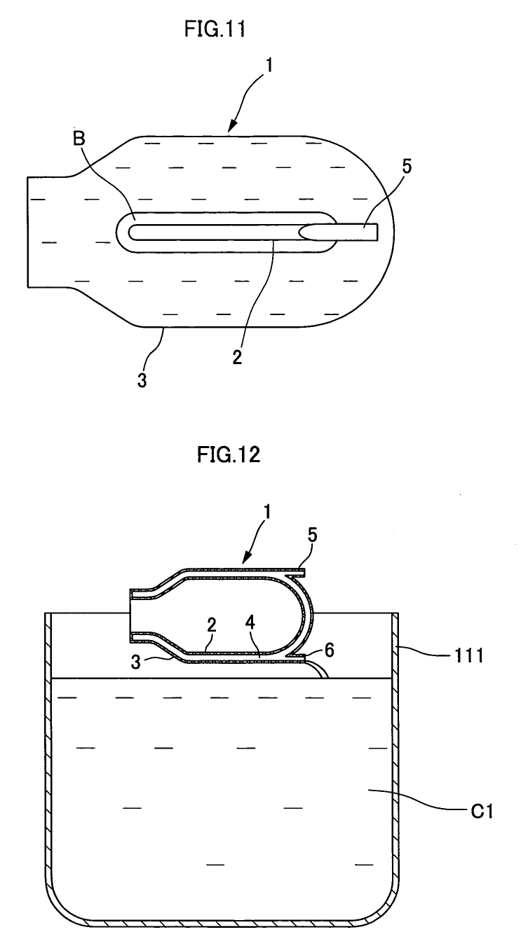

FIGS. 9 to 15 illustrate one example of the second embodiment of the present invention. A double glass vessel 1, to which no metal films are yet to have been applied (silver plating) on the outer surface of an inner vessel and the inner surface of an outer vessel, is the same as that used in the first embodiment of the present invention. The operation for applying silver plating to the other surface of the inner vessel 2 and the inner surface of the outer vessel 3 which face the vacuum insulating layer forming portion 4, leaving strip-shaped unapplied portions thereof in the direction of the vessel height is carried out in the following manner. First, as shown in FIG. 9 the double glass vessel 1 is positioned with its axis in the horizontal direction and with one tip tube 5 located at an upper position, and the double glass vessel 1 under this condition is immersed in a first chemical solution C1 for forming a metal film (first silver plating producing chemical solution), for example, an aqueous tin (IV) chloride solution. While the air in the vacuum insulating layer forming portion 4 is exhausted through the tip tube 5 located at the upper position, the first silver plating producing chemical solution C1 is injected or drawn into the vacuum insulating layer forming portion 4 through the other tip tube 6 located at the lower position. As shown in FIGS. 10 and 11, the first silver plating producing chemical solution C1 is injected into the vacuum insulating layer forming portion 4 until an air bubble B in the form of a strip in the direction of the vessel height remains at portions of the outer surface of the inner vessel and the inner surface of the outer vessel. Under this condition, the vessel is left in this state for a few minutes and thereafter the double glass vessel 1 is lifted from the first silver plating producing chemical solution C1 as shown in FIG. 12 so that the first silver plating producing chemical solution C1 in the vacuum insulating layer forming portion 4 is discharged through the tip tube 6 located at the lower position and until it is completely out.

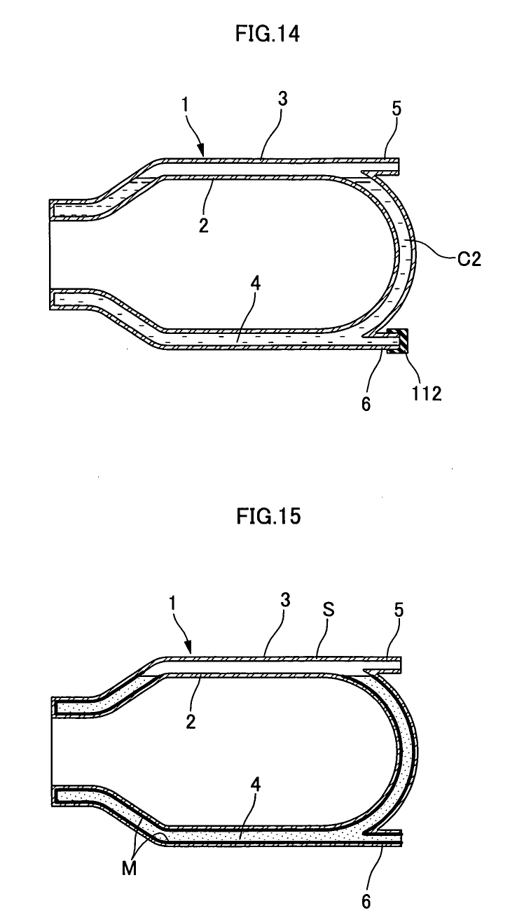

As shown in FIG. 13, thereafter, the lower tip tube 6 is closed by a plug or cap 112 and a second chemical solution (second silver plating producing chemical solution) C2 for forming a metal film, for example, a silver mirror reaction chemical solution such as an aqueous silver nitrate solution is injected from the upper tip tube 5 into the vacuum insulating layer forming portion 4. The injecting of the second silver plating producing chemical solution C2 into the vacuum insulating layer forming portion 4 is performed while the air in the vacuum insulating layer forming portion 4 is being exhausted through a clearance between the inner periphery surface of the tip tube 5 and the outer periphery surface of a tube 114 which is connected to a chemical solution vessel 113 and inserted through the tip tube 5 into the vacuum insulating layer forming portion 4. Moreover, the injecting of the second silver plating producing chemical solution into the vacuum insulating layer forming portion 4 may also be carried out in the manner as shown in FIG. 4. The double glass vessel with the vacuum insulating layer forming portion 4 filled with a predetermined amount of the second silver plating producing chemical solution C2 as shown in FIG. 14 is left in this state for a few minutes, and thereafter the plug or cap 112 is removed from the lower tip tube 6 so that the second silver plating producing chemical solution C2 in the vacuum insulating layer forming portion 4 is discharged through the lower tip tube 6 located at the lower position. Consequently, as shown in FIG. 15, the silver plating M is applied onto the outer surface of the inner vessel and the inner surface of the outer vessel which have contacted the respective silver plating producing chemical solutions C1 and C2, and the strip-shaped metal film unapplied portions, which have not contacted the respective silver plating producing chemical solutions, remain to form transparent slits S in the direction of the vessel height.

After the silver plating M has been applied onto the outer surface of the inner vessel and the inner surface of the outer vessel having the transparent slits S in this manner, the vacuum insulating layer forming portion 4 is evacuated by the use of the tip tubes 5 and 6 to form the vacuum insulating layer between the inner and outer vessels 2 and 3, and the tip tubes 5 and 6 are then sealed in the same manner as in the first embodiment of the present invention to obtain a vacuum insulating double glass vessel 10 similar to that shown in FIG. 5.

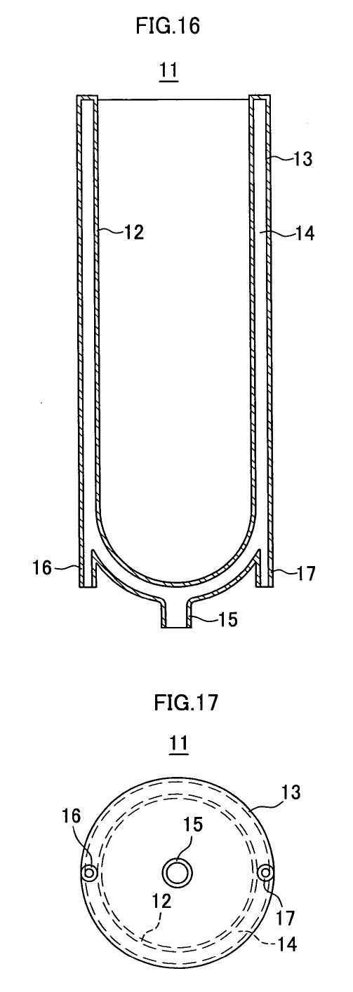

FIGS. 16 to 19 illustrate one example of the third embodiment of the present invention. As shown in FIGS. 16 and 17, a double glass vessel 11, which has not been provided with silver plating as metal films, has a vacuum insulating layer forming portion 14 between an inner vessel 12 and an outer vessel 13 by welding together the inner and outer vessels at their upper openings. The outer vessel 13 is provided at three locations on its bottom with tip tubes 15, 16 and 17 opening into the vacuum insulating layer forming portion 14. In more detail, there are provided the first tip tube 15 having a comparatively larger opening diameter at the center of the bottom, and the second tip tube 16 and the third tip tube 17 having a comparatively smaller opening diameter and at diametrically opposite positions on both the sides of the first tip tube 15 on the outer periphery of the bottom and be flush with the drum portion of the outer surface of the outer vessel 13.

The respective tip tubes 15, 16 and 17 are used as passages for injecting and discharging the chemical solutions for applying metal films (silver plating) onto the outer surface of the inner vessel and the inner surface of the outer vessel which face the vacuum insulating layer forming portion 14 and as air passages when injecting and discharging the chemical solutions. After the silver plating has been completed, the two tip tubes are sealed except for the one tip tube, and the vacuum insulating layer forming portion 14 is evacuated through the remaining tip tube to change the vacuum insulating layer forming portion 14 to a vacuum insulating layer. Thereafter, the remaining tip tube is also sealed so that there are the sealed vestiges of the tip tubes 15, 16 and 17 at the bottom of the outer vessel 13.

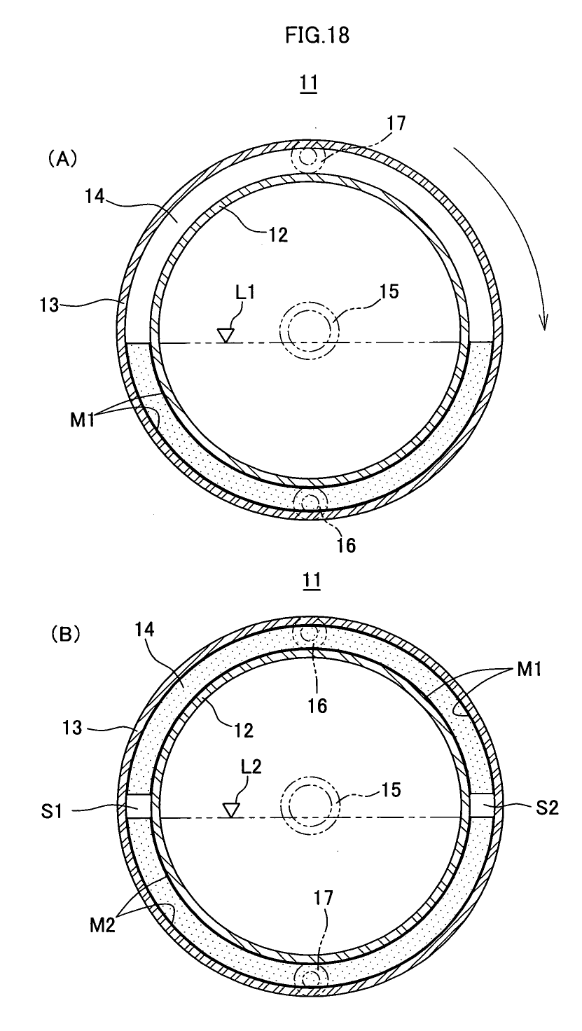

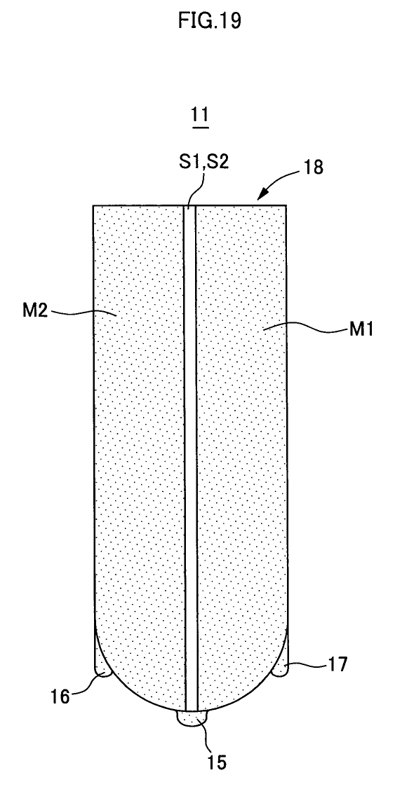

The three tip tubes of the double glass vessel 11 are used as passages for the vacuum insulating layer forming portion 14 for injecting and discharging the chemical solutions and for suction and exhaust of the air to apply the silver plating onto the inner surfaces of the vacuum insulating layer forming portion 14 according to the procedure shown in FIG. 18. Thereafter, the sealing of the tip tubes 15, 16 and 17 and evacuation are performed so that a vacuum insulating double glass vessel 18 can be obtained which has silver plating layers M1 and M2 formed with two transparent slits S1 and S2 parallel to each other in the direction of the vessel height at locations 180 degrees opposed to each other as shown in FIG. 19.

First, as shown in FIG. 18A the double glass vessel 11 is positioned with its axis in the horizontal direction and with one tip tube, for example, the second tip tube 16, located at the lowermost position, and under this condition, the first silver plating producing chemical solution, for example, an aqueous tin (IV) chloride solution is injected into the vacuum insulating layer forming portion 14 through the second tip tube 16 located at the lower position or through the first tip tube 15 with the second tip tube 16 being closed. In this case, the air in the vacuum insulating layer forming portion 14 is exhausted through the other tip tube or the first tip tube 15 located at the upper position and the third tip tube 17 so that the chemical solution can be easily injected into the vacuum insulating layer forming portion 14. The first silver plating producing chemical solution is injected into the vacuum insulating layer forming portion 14 by a predetermined amount of the solution, or until the liquid level of the solution arrives at a predetermined position, or immediately before the solution is about to overflow from the first tip tube 15 or until the solution overflows, thereby obtaining the condition of the vacuum insulating layer forming portion 14 filled with the solution to its predetermined level L1. The double glass vessel is left in this state for a few minutes and thereafter the second tip tube 16 is opened to discharge the first silver plating producing chemical solution.

Next, the double glass vessel 11 is retained in this condition, while the second silver plating producing chemical solution or silver mirror reaction chemical solution, for example, an aqueous silver nitrate solution is injected through the second tip tube 16 or the first tip tube 15 into the vacuum insulating layer forming portion 14. The silver mirror reaction chemical solution is also injected into the portion 14 by a predetermined amount thereof, or until the level of the solution arrives at a predetermined level, or immediately before the solution is about to overflow, or until it overflows so that the solution in the vacuum insulating layer forming portion arrives at a predetermined level L1. By performing such a first silver plating forming operation, the first silver plating Ml is applied onto the inner and outer glass surfaces on the side of the second tip tube 16 which have contacted the respective silver plating producing chemical solutions.

After the silver plating M1 has been applied to the one half of the vessel drum in this manner, the second silver plating producing chemical solution has been discharged through the second tip tube 16 and the insulating layer forming portion has been cleaned, the double glass vessel 11 is rotated about its axis through 180 degrees and thereafter the second silver plating forming operation is performed on the remaining one half of the vessel drum in the same manner described above. In more detail, as shown in FIG. 18B the first silver plating producing chemical solution is injected into the vacuum insulating layer forming portion 14 through the third tip tube 17 moved to the lower position or through the first tip tube 15 with the third tip tube 17 being closed by a predetermined amount of the solution, or until the level of the solution arrives at a predetermined level, or until the solution overflows through the first tip tube 15 so that the solution in the vacuum insulating layer forming portion 14 arrives at a predetermined level L2 to form a strip-shaped metal film unapplied portion in the direction of the vessel height between the solution and the silver plating M1 already formed in the previous operation. Under this condition, by carrying out the second silver plating forming operation the silver plating M2 is applied to the inner and outer glass surfaces on the side of the third tip tube 17, which have contacted the silver plating producing chemical solution.

In this manner, using the respective tip tubes 15, 16 and 17 as the passages for injecting and discharging the chemical solutions and passages of the air when the injecting and discharging the chemical solutions, the operations for injecting the predetermined amounts of the silver plating producing chemical solutions into the vacuum insulating layer forming portion 14 are carried out two times before and after the rotation of the double glass vessel 11 through 180 degrees. In the operation of the second time, the silver plating M2 of the second time is applied so as not to contact the silver plating M1 applied in the operation of the first time so that the transparent slits S1 and S2 consisting of silver plating unapplied portions (metal film unapplied portions) in the direction of the vessel height can be formed between both the silver plating M1 and M2 (metal film applied portions).

Particularly, by providing at the center of the bottle the first tip tube 15 having an inner diameter larger than the width of the transparent slits S1 and S2 to be formed, if the liquid surface of the silver plating producing chemical solution injected into the vacuum insulating layer forming portion 14 exceeds a predetermined height, the excess silver plating producing chemical solution will overflow through the first tip tube 15 to flow out of the forming portion 14. Therefore, even if there are variances in volumes of the vacuum insulating layer forming portions 14 of the double glass vessels owing to manufacturing tolerances of the inner and outer vessels, the liquid level L1 and L2 of the silver plating producing chemical solutions in the vacuum insulating layer forming portion 14 can be securely set at a predetermined height so that the transparent slit S having a predetermined width can be surely formed. This eliminates the need to manage the amount of the chemical solutions exactly so that the workability of solution injection can be remarkably improved and automation of the operation becomes easy.

Moreover, by leaving the inner peripheral faces of the second and third tip tubes 16 and 17 at the outer periphery of the vessel flush with the inner peripheral surface of the outer vessel 13, the chemical solutions can be completely discharged from the vacuum insulating layer forming portion 14. Moreover, when injecting or discharging the chemical solutions, the suction and exhaust of the air can be effected through the other tip tubes with a high efficiency so that the injecting and discharging of the chemical solutions can be smoothly and surely performed.

In the event that wider transparent slits are desired, moreover, it can be achieved by stopping the injection of the silver plating producing chemical solutions before they overflow at the first tip tube 15. The width of the transparent slits S1 and S2 can be regulated arbitrarily by adjusting the injection amount of the silver plating producing chemical solutions into the vacuum insulating layer forming portion 14. Moreover, two transparent slits having different widths can be formed by slight deviation of the rotating angle of the double glass vessel 11 from 180 degrees after the formation of the first silver plating forming operation.

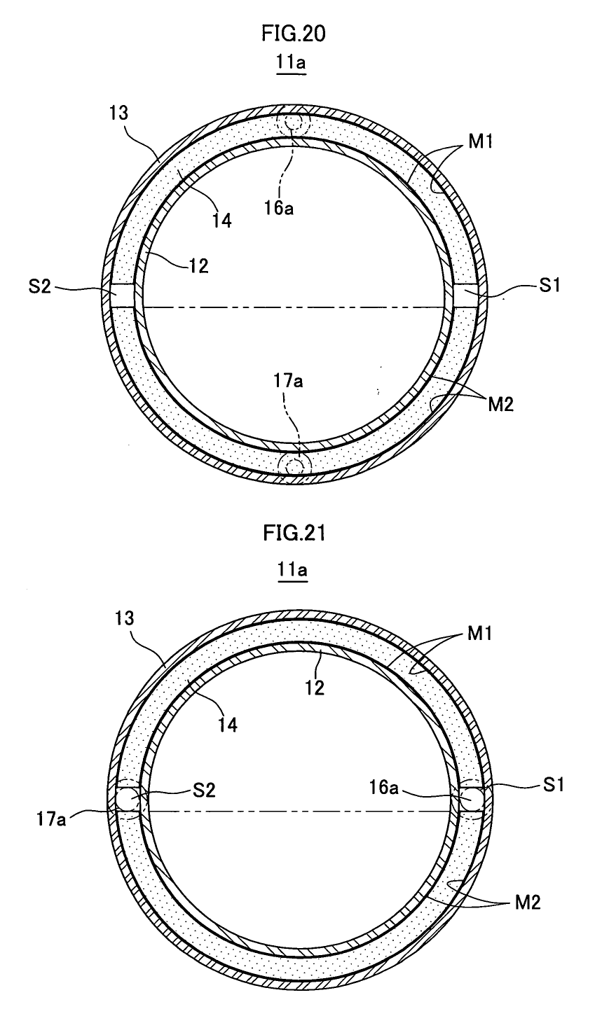

FIGS. 20 and 21 illustrate one example of the fourth embodiment of the present invention. A double glass vessel 11a shown in the example of this embodiment does not include the first tip tube at the center of the bottom as in the example of the second embodiment and includes two tip tubes 16a and 17a in 180 degrees opposite positions on the periphery of the bottom of the double glass vessel 11a.

In the double glass vessel 11a provided with the two tip tubes 16a and 17a in this manner, similarly, a predetermined amount of the silver plating producing chemical solution is injected into and then discharged from the vacuum insulating layer forming portion 14 of the double glass vessel with its one tip tube 16a located at the lowermost position to form the first silver plating Ml and then the double glass vessel 11a is rotated about its axis through 180 degrees. Thereafter, a predetermined amount of the silver plating producing chemical solution is injected into and then discharged from the vacuum insulating layer forming portion 14 through the other tip tube 17a to form the second silver plating M2 so that two transparent slits S1 and S2 in the direction of the vessel height can be formed between the silver plating layers Ml and M2 in the same manner as in the example of the first embodiment of the present invention.

In the double glass vessel 11a of the third embodiment of the present invention, moreover, as shown in the sectional view of FIG. 21 the operation for injecting and discharging the silver plating producing chemical solutions into and from the vacuum insulating layer forming portion 14 through one or both the tip tubes 16a and 17a located at the horizontal position is performed two times before and after the rotation of the double glass vessel 11a through 180 degrees so that the two transparent slits S1 and S2 in the direction of the vessel height can be formed between the silver plating layers M1 and M2 in the similar manner to that described above.

Especially in this case, at least either one of the tip tubes 16a and 17a is formed to have an inner diameter corresponding to a width of the transparent slits S1 and S2 and the silver plating producing chemical solution is injected into the vacuum insulating layer forming portion 14 through the other tip tube until the solution starts to overflow through the first mentioned tip tube so that the liquid level of the silver plating producing chemical solution in the vacuum insulating layer forming portion 14 can be securely set at a predetermined height.

In the case of providing two tip tubes which are the first tip tube 15 at the center of the bottom and one of the tip tubes on the outer periphery of the bottom in the second embodiment, the two transparent slits S1 and S2 in the direction of the vessel height can also be formed between the silver plating layers M1 and M2 by performing the similar operation with both the tip tubes positioned in the horizontal direction.

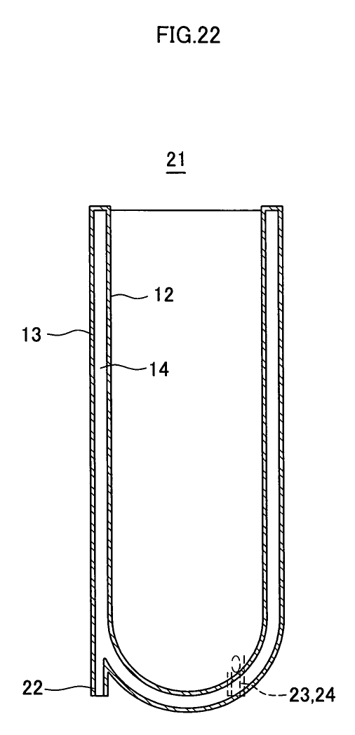

FIGS. 22 to 24 illustrate one example of the fifth embodiment of the present invention. In this embodiment, a double glass vessel 21 provided with a vacuum insulating layer forming portion 14 between an inner vessel 12 and an outer vessel 13 in the same manner as those described above is provided at three locations with tip tubes 22, 23 and 24 equally spaced (120 degrees spaced) at the periphery of the bottom of the double glass vessel 21. First to third silver plating forming operations are performed using the three tip tubes, respectively, whereby silver plating layers M11, M12 and M13 having three transparent slits S11, S12 and S13 in the direction of the vessel height are applied to the vacuum insulating layer forming portion.

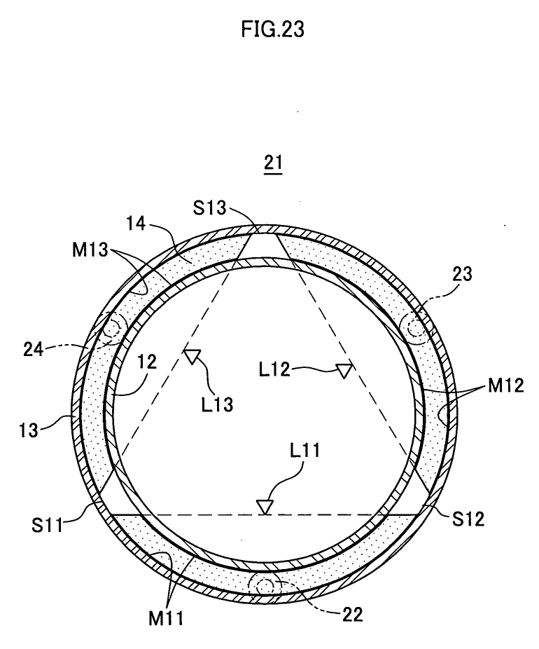

In applying the silver plating layers to the vacuum insulating layer forming portion of the double glass vessel 21, as shown in FIG. 23 the double glass vessel 21 is positioned in the horizontal direction with the one tip tube 22 located at the lower position. Under this condition, a first silver plating forming operation is carried out in such a manner that each of the silver plating producing chemical solution is injected into and then discharged from the vacuum insulating layer forming portion through the tip tube 22 to a predetermined liquid level L11 to form the first silver plating layer M11 over approximately one-third of the vessel drum. Thereafter, the double glass vessel 21 is rotated about its axis through 120 degrees with the tip tube 23 located at the lower position, and a second silver plating forming operation is carried out in such a manner that each of the silver plating producing chemical solution is injected into and then discharged from the vacuum insulating layer forming portion through the tip tube 23 to a predetermined liquid level L12 or so as not to contact the silver plating M11 formed in the first silver plating forming operation on the side of the tip tube 22 to form the required gap so that the second silver plating M12 is formed on the drum of the vessel on the side of the tip tube 23.

On the side of the third tip tube 24, moreover, a third silver plating forming operation is carried out to a predetermined liquid level L13 in the same manner as those described above to form a third silver plating M13 on the vessel drum on the side of the tip tube 24 so that three transparent slits S11, S12 and S13 having a predetermined width are formed in parallel with one another in the direction of the vessel height.

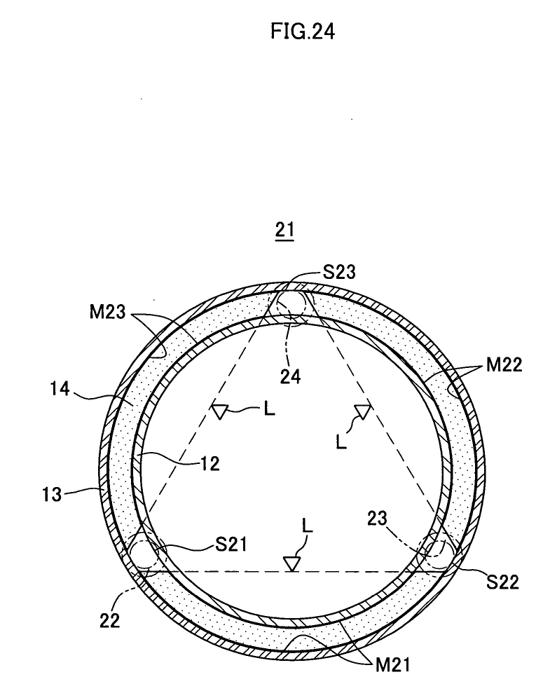

By suitably setting the inner diameters of the respective tip tubes 22, 23 and 24 of the double glass vessel 21, moreover, as shown in FIG. 24 with the tip tubes 22 and 23 located substantially in the horizontal direction, each of the silver plating producing chemical solutions is injected through the one tip tube 22 and caused to overflow through the other tip tube 23, thereby enabling the liquid level to be controlled at a predetermined height as well. In this case, silver plating forming operations in three steps are carried out with a combination of the tip tubes 22 and 23, a combination of the tip tubes 23 and 24, and a combination of the tip tubes 22 and 24 to a predetermined liquid level L to form silver plating layers M21, M22 and M23 having three transparent slits S21, S22 and S23 parallel in the direction of the vessel height with widths corresponding to inner diameters of the respective tip tubes. Moreover, the chemical solution is discharged from the vacuum insulating layer forming portion 14, while the vessel end on its opening side is slowly raised so that adherence of the chemical solutions to the transparent slit forming portions can be suppressed to the minimum on the side of the vessel bottom.

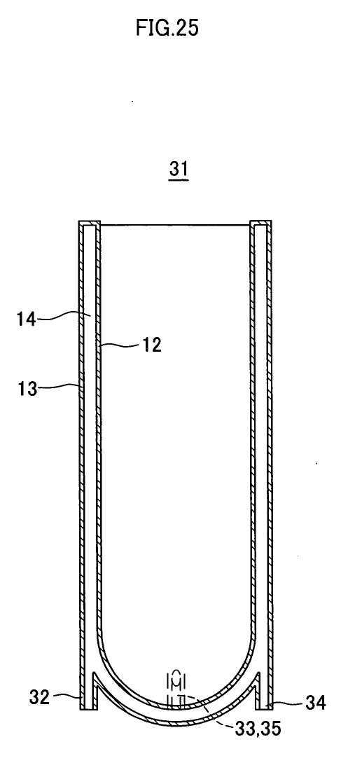

FIGS. 25 to 28 illustrate one example of the sixth embodiment of the present invention. In this embodiment, similarly to those described above, a double glass vessel 31 having a vacuum insulating layer forming portion 14 between inner and outer vessels 12 and 13 is provided at the periphery of its bottom with tip tubes 32, 33, 34 and 35 equally spaced (90 degrees spaced) at four locations. First to fourth silver plating forming operations are carried out sequentially using the four tip tubes, respectively, to a predetermined liquid level L to form silver plating layers M31, M32, M33 and M34 having four transparent slits S31, S32, S33 and S34 parallel to one another in the direction of the vessel height.

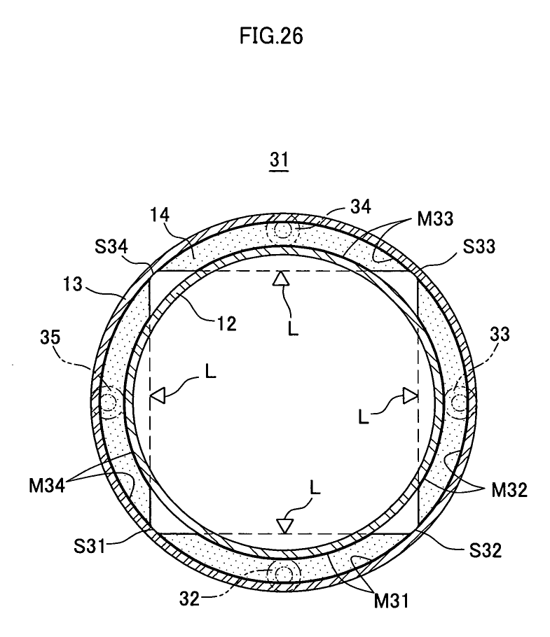

In the double glass vessel 31 provided with the four tip tubes as well, as shown in FIG. 26 the double glass vessel 31 is positioned in the horizontal direction, and under this condition, each of the silver plating producing chemical solutions is injected into and then discharged from the vacuum insulating layer forming portion through each of the tip tubes to a liquid level L. The double glass vessel 31 is then rotated in increments of 90 degrees and after every rotation the above injecting and discharging of the solution is performed to form silver plating on about one-fourth of the vessel drum so that the double glass vessel is ultimately formed with silver plating layers M31, M32, M33 and M34 with four transparent slits S31, S32, S33 and S34 parallel to one another in the height direction of the vessel having a predetermined width.

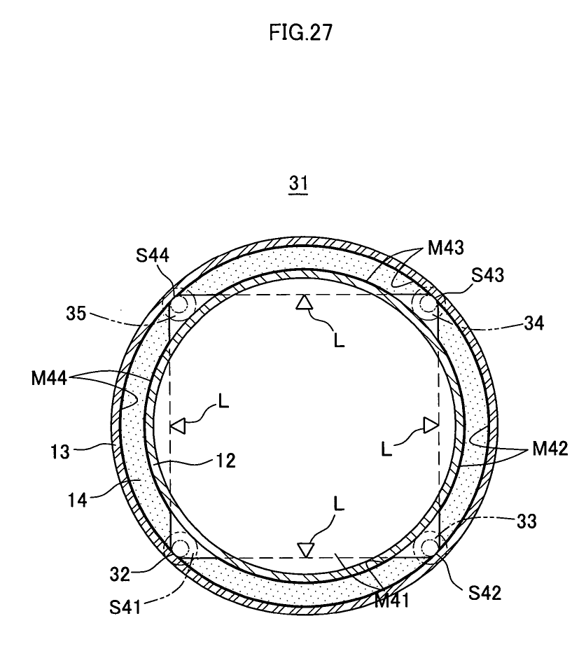

As shown in FIG. 27, moreover, the double glass vessel is arranged with the adjacent tip tubes 32, 33, 34 and 35 located substantially in the horizontal direction, and each of the silver plating producing chemical solution is injected through the one tip tube and caused to overflow through the other tip tube so that the liquid level can be controlled to be at a predetermined height L. In this case, also the double glass vessel 31 is rotated in increments of 90 degrees and after every rotation the silver plating forming operation is carried out with a combination of the tip tubes 32 and 33, a combination of the tip tubes 33 and 34, a combination of the tip tubes 34 and 35, and a combination of the tip tubes 32 and 35 so that the vacuum insulating layer forming portion of the double glass vessel is formed at four locations with silver plating layers M41, M42, M43 and M44 having four transparent slits S41, S42, S43 and S44 in the direction of the vessel height.

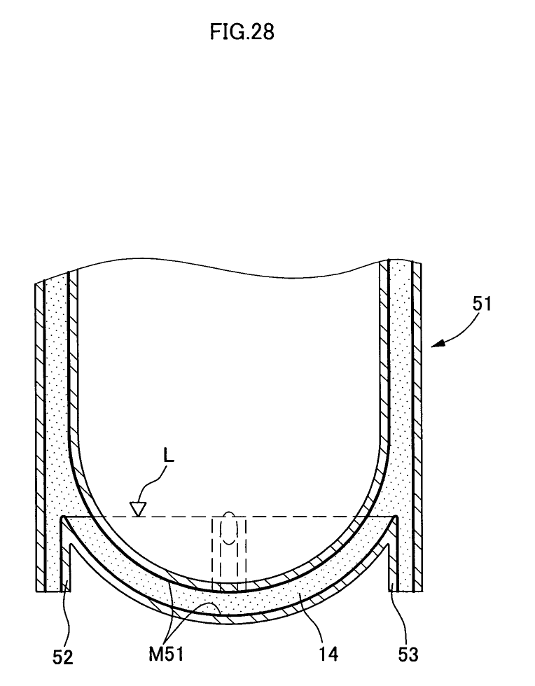

Moreover, depending on the amount of solution injected into the vacuum insulating layer forming portion 14, sufficient silver plating may not be applied to a vessel bottom where transparent slits are not needed. In order to solve this problem, as shown in FIG. 28 with the double glass vessel 51 standing upright, the silver plating producing chemical solution is injected into the vacuum insulating layer forming portion 14 through any tip tube 52 until the solution arrives at a predetermined liquid level L so that the silver plating M51 is applied to the whole surface of the vessel bottom, thereby enabling the vacuum insulating property of this portion to be improved. In this case, the air in the vacuum insulating layer forming portion 14 can also be sucked and exhausted through the other tip tube 53 so that the injecting and discharging of the chemical solutions can be performed smoothly.

After the predetermined silver plating has been applied to the outer surface of the inner vessel and the inner surface of the outer vessel which face the vacuum insulating layer forming portion between the inner vessel and the outer vessel of glass which is a transparent material in this manner, a plurality of tip tubes are sealed with their openings except for one tip tube, and the vacuum insulating layer forming portion is evacuated through the one tip tube which is then sealed with its opening, thereby obtaining a vacuum insulating double glass vessel provided with a plurality of transparent slits in the direction of the vessel height at portions of the silver plating layers applied to the vacuum insulating layer between the inner vessel and the outer vessel.

Any material may be used as the transparent material for forming the vacuum insulating double vessel. A transparent synthetic resin may be used in addition to the glass exemplarily shown in the examples of the respective embodiments of the present invention. As the metal film for suppressing radiation, various metal plating layers hitherto used other than the silver plating described above may also be employed, for example, electroless plating layers using copper, nickel, gold, tin or the like. Moreover, the vacuum insulating double vessel according to the present invention can also be used as a vacuum insulating vessel such as a heat reserving vessel and a cold reserving vessel other than a so-called vacuum bottle. Instead of the vacuum insulating layer, it may be possible to employ a so-called gas vacuum insulation or air vacuum insulation filled with a low heat conductivity gas.

1. A vacuum insulating double vessel including a vacuum insulating layer provided between an inner vessel and an outer vessel of the double vessel made of a transparent material, and metal films applied to the outer surface of the inner vessel and the inner surface of the outer vessel which face the vacuum insulating layer,
the vacuum insulating double vessel comprising strip-shaped metal film unapplied portions in a vessel height direction in the metal film applied portions, and a plurality of opening vestiges, on the outer vessel, which result from sealing a plurality of openings used for injecting and discharging chemical solutions for applying the metal films, used as air passages and used for evacuating a space between the inner and outer vessels.

2. The vacuum insulating double vessel according to claim 1, wherein the transparent material is glass.

3. The vacuum insulating double vessel according to claim 1, wherein tip tubes are used for the openings.

4. The vacuum insulating double vessel according to claim 1, wherein a plurality of the openings are provided at opposite positions on the outer periphery of the bottom of the outer vessel.

5. A method for manufacturing a vacuum insulating double vessel including a vacuum insulating layer provided between an inner vessel and an outer vessel of the double vessel made of a transparent material, and metal films applied to the outer surface of the inner vessel and the inner surface of the outer vessel which face the vacuum insulating layer,
the method comprising the steps of locating, at an upper position, one opening of a plurality of openings provided in the outer vessel in a condition where an axis of the double vessel before formation of the metal films is directed to a horizontal direction; injecting a chemical solution for forming metal films into the space between the inner vessel and the outer vessel while exhausting air in a space between the inner vessel and the outer vessel to apply the metal film onto the outer surface of the inner vessel and the inner surface of the outer vessel except for portions of the outer surface and the inner surface in the form of a strip in the direction of the vessel height; locating, at a lower position, one opening of the plurality of openings to discharge the chemical solution; evacuating the space between the inner vessel and the outer vessel of the double vessel through the opening; and then sealing the openings to form a vacuum insulating layer between the inner vessel and the outer vessel.

6. The method for manufacturing the vacuum insulating double vessel according to claim 5, wherein a width of the portions to which the metal films are not applied is regulated by adjusting a rotating angle of the double vessel after the chemical solution for forming the metal films has been injected into the space between the inner vessel and the outer vessel.

7. A method for manufacturing a vacuum insulating double vessel including a vacuum insulating layer provided between an inner vessel and an outer vessel of the double vessel made of a transparent material, and metal films applied to the outer surface of the inner vessel and the inner surface of the outer vessel which face the vacuum insulating layer,
the method comprising the steps of directing, in a horizontal direction, an axis of double vessel before formation of the metal films; immersing the double vessel into a chemical solution for forming the metal films in a condition where one opening of a plurality of openings provided in the outer vessel is located at an upper position; injecting a first chemical solution for forming the metal films into a space between the inner vessel and the outer vessel through the opening, located at a lower position, of a plurality of the openings until there is reached such a state that portions of the outer surface of the inner vessel and the inner surface of the outer vessel are left in the form of a strip in the direction of the vessel height, while exhausting air in the space between the inner vessel and the outer vessel through the opening located at the upper position; locating, at a lower position, one opening of a plurality of the openings to discharge the first chemical solution through the one opening; locating, at an upper position, one opening of a plurality of the openings provided in the outer vessel; injecting a second chemical solution for forming the metal films into the space between the inner vessel and the outer vessel while exhausting air in the space between the inner vessel and the outer vessel through the opening to apply the metal films to the outer surface of the inner vessel and the inner surface of the outer vessel, portions of the outer surface of the inner vessel and the inner surface of the outer vessel being left in the form of a strip in the direction of the vessel height; locating, at a lower position, one opening of the plurality of openings to discharge the second chemical solution through the opening; evacuating the space between the inner vessel and the outer vessel of the double vessel thorough the opening; and then sealing the openings to form a vacuum insulating layer between the inner vessel and the outer vessel.
